(19) United States
(12) Patent Application Publication
(10) Pub. No.: US 2025/0244267 A1
(43) Pub. Date: Jul. 31, 2025

(54) SURFACE TEMPERATURE ASSESMENT OF ULTRAWIDE BANDGAP MATERIALS USING VISIBLE WAVELENGTH THERMOREFLECTANCE THERMAL IMAGING (TTI)

(71) Applicant: The Government of the United States of America, as represented by the Secretary of the Navy, Arlington, VA (US)

(72) Inventors: James Spencer Lundh, Gaithersburg, MD (US); Marko J. Tadjer, Vienna, VA (US); Alan G. Jacobs, Rockville, MD (US); Karl D. Hobart, Alexandria, VA (US); Cory D. Cress, Washington, DC (US); Georges Pavlidis, East Hartford, CT (US); Muhammad Saad Jamil, North Windham, CT (US)

(73) Assignee: The Government of the United States of America, as represented by the Secretary of the Navy, Arlington, VA (US)

(21) Appl. No.: 19/040,938

(22) Filed: Jan. 30, 2025

Related U.S. Application Data
(60) Provisional application No. 63/627,484, filed on Jan. 31, 2024.

(51) Int. Cl. G01N 25/00

(52) U.S. Cl. CPC G01N 25/00

(57) ABSTRACT

A system and method for surface temperature assessment of ultrawide bandgap semiconductors via thermoreflectance thermal imaging (TTI) are provided. In implementations, a method includes: determining an optimal sub-bandgap measurement wavelength for the ultrawide bandgap material based on relative changes in reflectivity of the ultrawide bandgap material as a function of wavelength; determining a thermoreflectance coefficient (C_{TR}) of the ultrawide bandgap material based on a change in reflectivity of the ultrawide bandgap material, illuminated at the optimal sub-bandgap measurement wavelength, as a function of temperature; and determining temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.

### CROSS-REFERENCE TO RELATED APPLICATIONS

This application is a Nonprovisional of, and claims the benefit of priority under 35 U.S.C. § 119 based on, U.S. Provisional Patent Application No. 63/627,484 filed Jan. 31, 2024. The Provisional application and all references cited herein are hereby incorporated by reference into the present disclosure in their entirety.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case No. 211873-US2.

### BACKGROUND OF THE INVENTION

Aspects of the present invention relate generally to thermal assessment of materials and, more particularly, to surface temperature assessment of ultrawide bandgap semiconductors via thermoreflectance thermal imaging (TTI).

Various methods exist for thermal assessment of materials. Pulse biasing is one technique for characterizing semiconductor materials, wherein a bias to the semiconductor material is pulsed such that the semiconductor material switches between an ON-state (wherein a temperature of the semiconductor material increases over time) and an OFF-state (wherein the semiconductor material temperature decreases over time). In electronics, the term biasing refers to a fixed direct current (DC) voltage or current applied to a terminal of an electrical component such as a diode of a semiconductor device.

To assess thermal performance of semiconductor materials, non-contact optical methods are typically employed, such as infrared thermography, Raman thermometry, and thermoreflectance thermal imaging (TTI). Infrared thermography allows rapid thermal measurements; however, its spatial resolution is poor and commonly underestimates the device peak temperature rise in semiconductors that are transparent to the IR radiation. Raman thermometry has better spatial resolution, but for beta-gallium oxide (β-Ga₂O₃), the sub-bandgap excitation wavelengths measure a through-thickness average temperature rise and similarly underestimate peak temperature rise. Modified Raman methods such as nanoparticle-assisted Raman thermometry and two-dimensional material assisted Raman thermometry allow temperature measurements of the semiconductor channel surface with better fidelity, but require additional sample preparation, contaminate the sample, and are not imaging techniques (low throughput).

In general, thermoreflectance is a technique that measures how a material's reflectivity changes as its temperature changes. TTI has been widely used to measure the thermal response of microelectronics devices under both steady state and transient operation due to its ability to acquire full-field thermal maps with sub-micrometer spatial resolution. Thermoreflectance is typically implemented with visible wavelength illumination, and occasionally with near-ultraviolet (UV) wavelengths (365 nm for GaN), but β-Ga₂O₃ (or other ultrawide bandgap semiconductors) would require deep-UV light emitting diodes (LEDs), which are not readily available, and expensive optics. Coating the sample with molybdenum disulfide (MoS₂) flakes or quantum rods (few hundreds of nm thick) has been shown to allow full field thermoreflectance imaging of the surface of the semiconductor channel, but this requires additional sample preparation and inevitably also contaminates the sample. Thus, there remains a need for new and accurate methods for ultrawide bandgap material assessment.

### SUMMARY OF THE INVENTION

In a first aspect of the invention, there is a method including: determining an optimal sub-bandgap measurement wavelength for the ultrawide bandgap material based on relative changes in reflectivity of the ultrawide bandgap material as a function of wavelength; determining a thermoreflectance coefficient (C_{TR}) of the ultrawide bandgap material based on a change in reflectivity of the ultrawide bandgap material, illuminated at the optimal sub-bandgap measurement wavelength, as a function of temperature; and determining temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.

In embodiments, identifying the optimal sub-bandgap measurement wavelength includes: illuminating the ultrawide bandgap material at a select probing wavelength; pulse-biasing the semiconductor device, at a set power level, between an ON-state and an OFF-state at the select probing wavelength for a period of time; capturing a set of images of reflectivity of light off the ultrawide bandgap material over the period of time; determining a relative change in reflectivity (ΔR/R₀) of the ultrawide bandgap material as a function of wavelength based on the set of images; reiterating the steps of illuminating, pulse-biasing, capturing the set of images and determining the relative change in reflectivity of the ultrawide bandgap material at multiple select probing wavelengths, thereby determining changes in reflectivity of the ultrawide bandgap material for the multiple select probing wavelengths; and determining the optimal sub-bandgap measurement wavelength based on the changes in reflectivity of the ultrawide bandgap material for the multiple probing wavelengths, wherein the optimal sub-bandgap measurement wavelength is one of the multiple probing wavelengths with a largest value of ΔR/R₀.

In implementations, the select probing wavelengths are wavelengths having an energy less than a bandgap energy of the ultrawide bandgap material. The select probing wavelengths may have an energy (E_{light}) that is less than the bandgap energy of the ultrawide bandgap material (E_{g}), wherein E_{g}−E_{light}>0.3 electronvolts (eV). In embodiments, the select probing wavelengths are selected from the range of 320-800 nanometers. In implementations, the period of time and the set power level result in a minimum temperature fluctuation of the semiconductor device between 5 and 10 degrees Celsius between the ON-State and the OFF-State.

In embodiments, determining the thermoreflectance coefficient (C_{TR}) of the ultrawide bandgap material includes: uniformly heating the semiconductor device to a first temperature while illuminated at the optimal sub-bandgap wavelength; capturing a first set of images of reflectivity of light off the ultrawide bandgap material at the first temperature; uniformly heating the semiconductor device at a second temperature while illuminated at the optimal sub-bandgap wavelength; capturing a second set of images of reflectivity of light off the ultrawide bandgap material at the second temperature; determining a change of reflectivity of the ultrawide bandgap material between at least the first temperature and the second temperature based on the first and second set of images; and determining the thermoreflectance coefficient (C_{TR}) of the ultrawide bandgap material based on the change of reflectivity of the ultrawide bandgap material between at least the first temperature and the second temperature. The determining of the thermoreflectance coefficient (C_{TR}) of the ultrawide bandgap material may be based on a pixel-by-pixel calibration map.

In embodiments, determining the temperature rise characteristics of the ultrawide bandgap material includes: pulse-biasing the semiconductor device between an ON-state and an OFF-state for a period of time at a select probing power level while exposed to light at the optimal sub-bandgap wavelength; capturing a set of images of reflectivity of the light off the ultrawide bandgap material averaged over the period of time; determining a change in reflectivity (ΔR/R₀) of the ultrawide bandgap material based on the set of images; reiterating the steps of pulse-biasing, capturing the set of images, and determining the relative change in reflectivity of the ultrawide bandgap material at multiple select probing power levels, thereby determining changes in reflectivity of the ultrawide bandgap material for the multiple select probing power levels; and determining the temperature rise characteristics of the ultrawide bandgap material based on the changes in reflectivity of the ultrawide bandgap material for the multiple select probing power levels.

In some implementations, determining the temperature rise characteristics of the ultrawide bandgap material includes: converting the changes in reflectivity of the ultrawide bandgap material for the multiple different probing power levels to a temperature rise map. In embodiments, the period of time and select probing power level result in a minimum temperature fluctuation of the semiconductor device between 5 and 10 degrees Celsius between the ON-State and the OFF-State. In embodiments, the peak temperature rise of the ultrawide bandgap material is determined based on the temperature rise characteristics. The ultrawide bandgap material may be gallium oxide or aluminum gallium oxide. The optimal sub-bandgap wavelength may be between 470-490 nanometers (nm).

In another aspect of the invention, there is a system including a processor set, one or more computer readable storage media, and program instructions collectively stored on the one or more computer readable storage media. The program instructions are executable to: determine a thermoreflectance coefficient (C_{TR}) of the ultrawide bandgap material based on a change in reflectivity of the ultrawide bandgap material, illuminated at an optimal sub-bandgap measurement wavelength, as a function of temperature; and determine temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.

The system may include: one or more light sources and a monochromator configured to illuminate the ultrawide bandgap material; one or more cameras configured to take images of the ultrawide bandgap material; a temperature-controlled stage configured to selectively heat the semiconductor device; and a power source configured to selectively bias the semiconductor device.

In another aspect of the invention, there is a computer program product including one or more computer readable storage media having program instructions collectively stored on the one or more computer readable storage media. The program instructions are executable to: determine a thermoreflectance coefficient (C_{TR}) of the ultrawide bandgap material based on a change in reflectivity of the ultrawide bandgap material, illuminated at an optimal sub-bandgap measurement wavelength, as a function of temperature; and determine temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a wavelength thermoreflectance thermal imaging (TTI) system in accordance with embodiments of the invention.

FIG. 2 is a cross-sectional view of a semiconductor device utilized in an experiment to quantify thermal performance of a semiconductor channel in accordance with implementations of the invention.

FIG. 3 depicts the change in reflectivity or thermoreflectance spectrum of the semiconductor device of FIG. 2 with respect to light wavelength in nanometers.

FIG. 4 depicts a graph plotting peak temperature rise (circles) in the channel of the semiconductor device of FIG. 2 as a function of the power density in watts per millimeter (W/mm).

FIG. 5A shows an exemplary thermoreflectance coefficient map for the β-Ga₂O₃ channel in the semiconductor device of FIG. 2 at a wavelength (λ) of 470 nm.

FIG. 5B shows exemplary temperature rise maps for the β-Ga₂O₃ channel in the semiconductor device of FIG. 2 given a wavelength (λ) of 470 nm at different power densities (i.e., 0.38 watts per millimeter (W/mm), 0.74 W/mm, 1.12 W/mm and 1.47 W/mm).

FIGS. 6A and 6B show a flowchart of an exemplary method in accordance with aspects of the present invention.

FIG. 7 shows an exemplary locked-in average measurement scheme in accordance with embodiments of the invention.

### DETAILED DESCRIPTION

Aspects of the present invention relate generally to thermal assessment of materials and, more particularly, to surface temperature assessment of ultrawide bandgap semiconductors via thermoreflectance thermal imaging (TTI). Embodiments of the invention provide a method to measure a surface temperature of homoepitaxially grown ultrawide bandgap devices using light within a certain wavelength range (e.g., 320-800 nanometers (nm)). In embodiments, the light is sub-bandgap visible wavelength light between 400-490 nm or 550-700 nm.

Ultrawide bandgap semiconductors are highly transparent to visible light, and it is generally recognized that deep-ultraviolet (UV) wavelengths are required to probe the change in temperature (ΔT) of such semiconductors. However, there is a finite amount of differential reflectance that can be measured using modulation-based spectroscopy at sub-bandgap visible wavelengths.

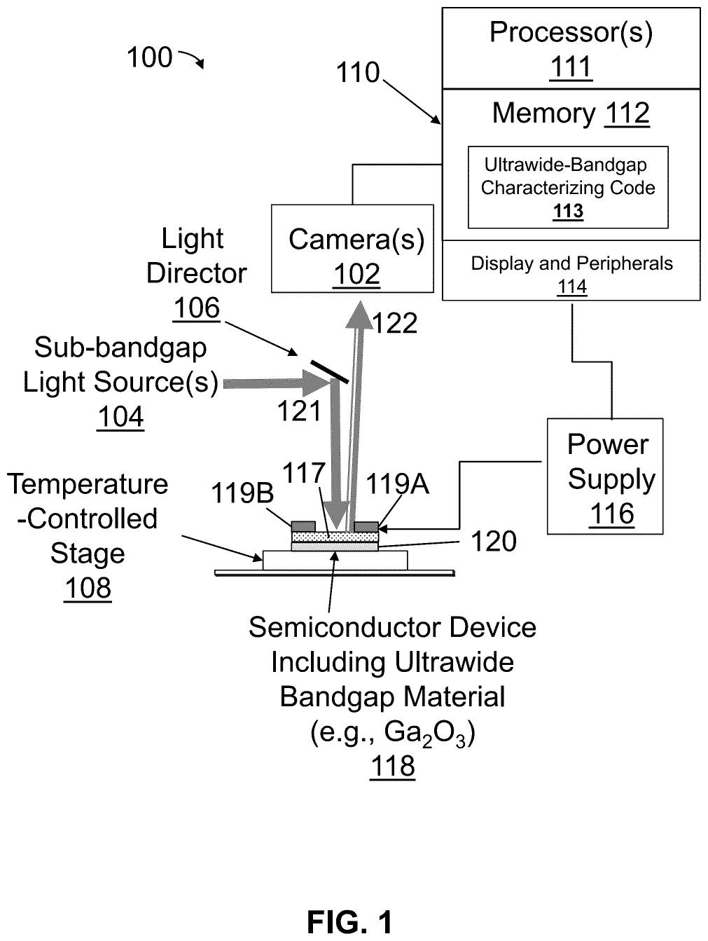

FIG. 1 depicts a wavelength thermoreflectance thermal imaging (TTI) system 100 in accordance with embodiments of the invention. In implementations, the TTI system 100 may be a conventional TTI system, such as a T° Imager®, which is a registered trademark of TMX Scientific®, modified with software to perform novel steps in accordance with embodiments of the invention. In implementations, the TTI system 100 includes one or more cameras 102 configured to capture images of light 122 reflecting off a surface of an ultrawide bandgap material to be characterized (represented at 117); one or more light sources 104 configured to provide a source of light 121 (e.g., in the visible spectrum) having a wavelength energy below the bandgap energy of the material to be characterized 117; (optionally) a light director 106 to direct light from the one or more light sources 104 toward the material to be characterized 117; a temperature control stage 108 configured to apply heat to the material to be characterized 117; a computer 110 configured to implement method steps of the invention as set forth below; and a power supply 116 configured to apply a bias to the material to be characterized 117.

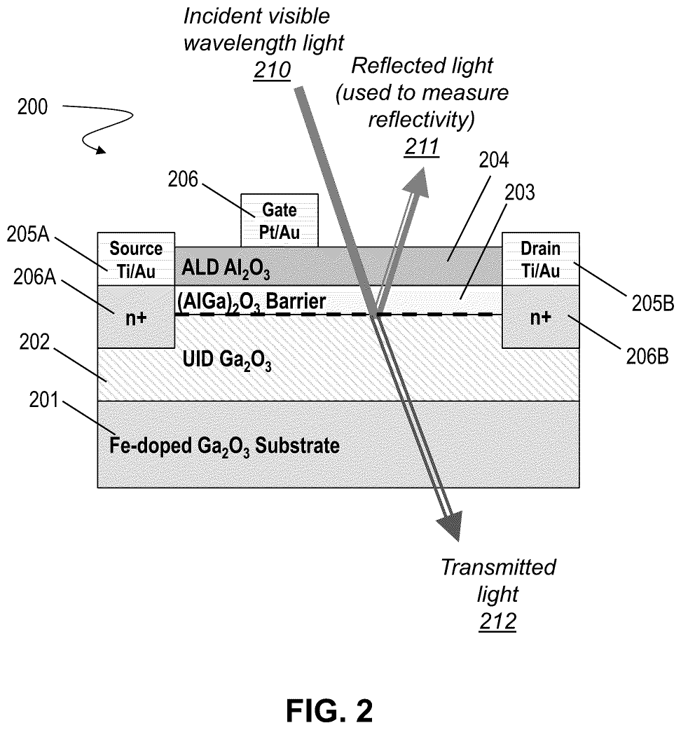

In implementations, the material to be characterized 117 is part of a semiconductor device 118 that includes at least two electrodes (e.g., 119A, 119B), thus enabling a bias to be applied to the material 117. In the example of FIG. 1, the semiconductor device 118 also includes a substrate 120 supporting the material to be characterized 117. The device 200 of FIG. 2 discussed below is one example of a device 118 that may be characterized in accordance with embodiments of the invention.

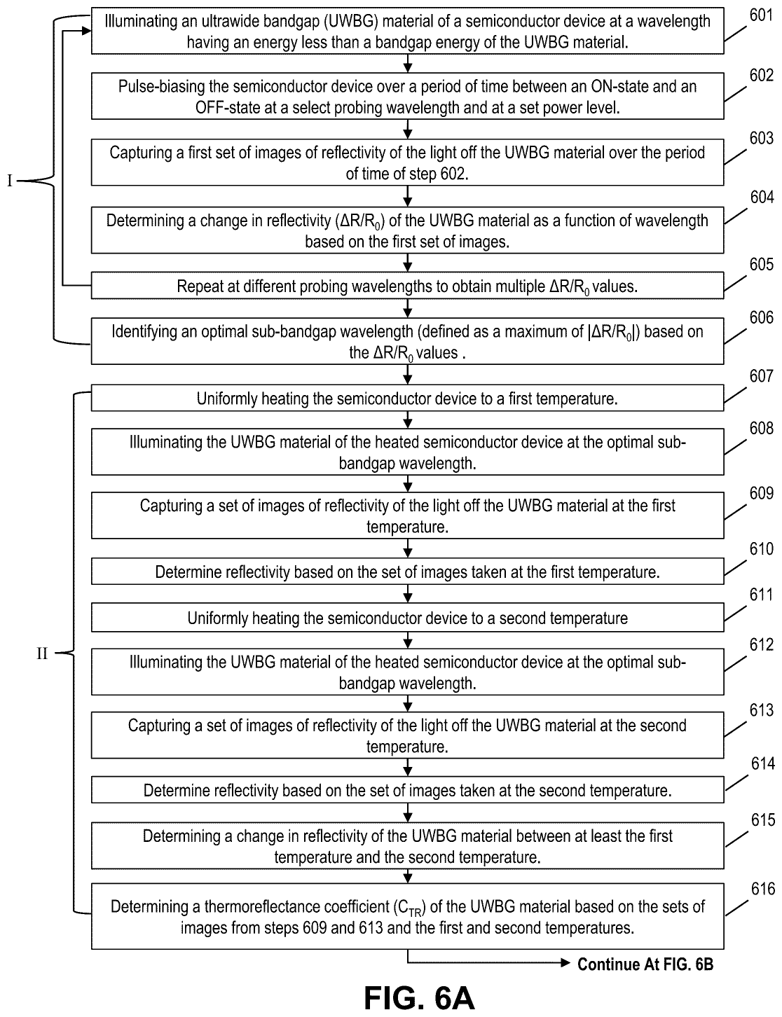

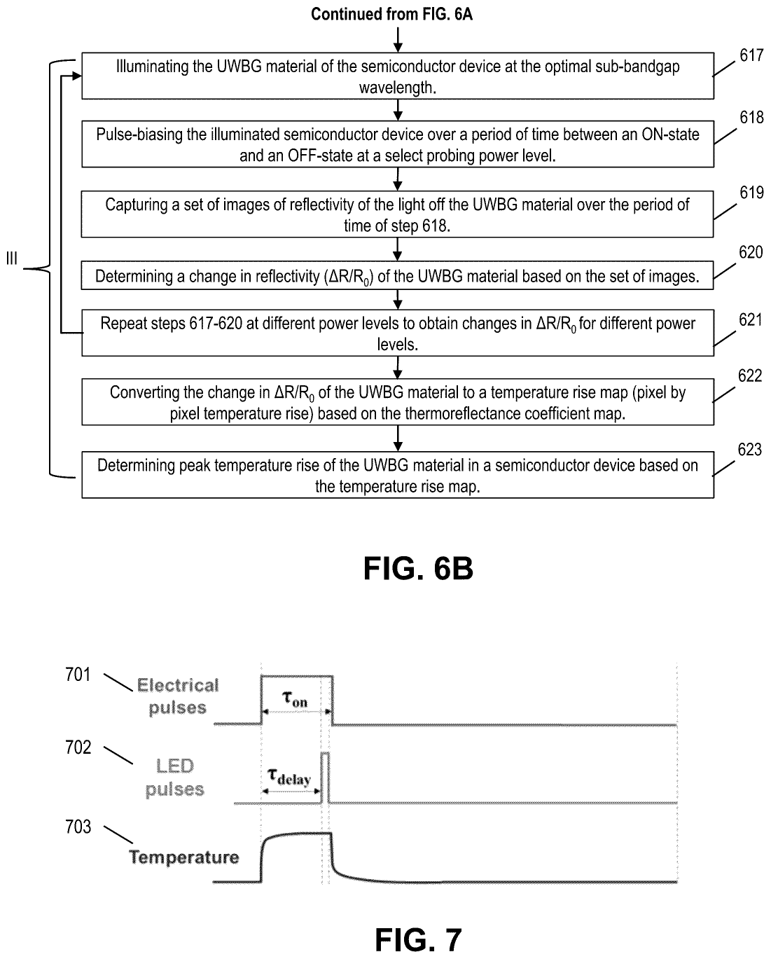

In embodiments, the computer 110 includes a processor set (one or more processors 111), one or more readable storage media (memory 112), program instructions (software code, e.g., 113) collectively stored on the one or more readable storage media, and a display and one or more peripherals generally indicated at 114. In embodiments, the program instructions are executable by the computer 110 to implement method steps set forth in FIGS. 6A and 6B, discussed below. In implementations, the material to be characterized 117 is an ultrawide bandgap material, such as Ga₂O₃ or another transparent semiconductor material.

Advantageously, implementations of the invention enable rapid two-dimensional temperature mapping of ultrawide bandgap devices under both steady-state and transient conditions, and enables users to quantify and locate “hot spots” to improve device reliability, identify potential failure sites, and assess thermal management. Moreover, implementations of the invention allow for rapid two-dimensional thermal mapping of semiconductors without sample contamination, long acquisition times, or sophisticated thermometry such as developing deep-ultraviolet compatible thermoreflectance systems.

### Exemplary Experiment

FIG. 2 is a cross-sectional view of a semiconductor device 200 utilized in an experiment to quantify thermal performance of a semiconductor channel in accordance with implementations of the invention. More specifically, thermoreflectance imaging with sub-bandgap visible wavelength light was used to measure a β-Ga₂O₃ channel temperatures of the semiconductor device 200, wherein the semiconductor device 200 was in the form of a β-(Al_{0.21}Ga_{0.79})₂O₃/Ga₂O₃ heterostructure field effect transistor (HFET). In general, the semiconductor device 200 was isothermally heated to known temperatures (T), and the measured reflectance (R) was measured at each T in order to determine the thermoreflectance coefficient (C_{TR}), then the semiconductor device 200 was pulse-biased and the R measured in ON and OFF states in order to determine a change in temperature (ΔT). It should be understood that the term pulse-biased as used herein refers to the process of applying an external voltage to a semiconductor device in a pulsed (ON/OFF) manner. Details of the experiment are discussed below.

The semiconductor device 200 analyzed included: a substrate 201 comprised of iron (Fe) doped Ga₂O₃; a 125 nanometer (nm) thick unintentionally doped (UID) β-Ga₂O₃ layer 202 grown on the substrate 201; a 21 nm thick β-(AlGa)₂O₃ barrier layer 203 grown with silicon (Si) delta-doping 3 nm above the interface of the barrier layer 203 and the UID β-Ga₂O₃ layer 202; and a 20 nm thick Al₂O₃ gate dielectric layer 204 deposited on the barrier layer 203 via atomic layer deposition. Additionally, regions 206A and 206B were formed within layers 202 and 203 by implanting those regions with Si and annealing to form the n+ regions. Further, first and second titanium/gold (Ti/Au) electrodes 205A, 205B were formed within the layers 202, 203 and 204 over the respective n+ regions 206A, 206B via electron-beam evaporation, and a gate electrode 206 of platinum/gold (Pt/Au) was formed on an upper surface of the layer 204 via electron-beam evaporation. The device 200 had a channel width of 75 micrometers (μm), channel length of 15.5 μm, gate length of 3 μm, drain-gate spacing of 10 μm, and source-gate spacing of 2.5 μm.

Thermoreflectance thermal imaging (TTI) was performed using a standard TTI system equipped with a monochromator and a multi-wavelength illumination module (light source) composed of 12 fiber-coupled LEDs. FIG. 2 depicts incident visible wavelength light 210 directed between the gate electrode 206 and the drain 205B of the semiconductor device 200, where a portion of the incoming light 210 is reflected off the Ga₂O₃ layer 202 as indicated at 211, and a portion of the light is transmitted through the Ga₂O₃ layer 202 as indicated at 212.

First, the relative change in reflectivity (ΔR/R₀) was measured as a function of wavelength to identify the optimal (i.e., maximum of ΔR/R₀) sub-bandgap measurement wavelength. For these measurements, ΔR is the change in reflectance of a device as it is pulsed-biased between the OFF-state (unheated, R₀) and ON-state (heated). A 100× objective and a fiber-coupled LEDs (470 nm probe wavelength) were used for the subsequent measurements. Point-by-point calibration maps were generated and used to convert the measured change in reflectance to temperature rise maps. All thermal measurements were performed with a base temperature of 20° C. Thermal maps were acquired by averaging over 100 frames.

At visible wavelengths of interest for thermoreflectance imaging (400-800 nm), approximately 15%-20% of the light incident upon the sample surface (e.g., 210 in FIG. 2) is reflected (e.g., 211 in FIG. 2). For thermoreflectance imaging, modulation of this reflectivity due to temperature changes (ΔT) can be calibrated and applied for device thermography. Assuming a linear relationship, this is realized by the introduction of a thermoreflectance coefficient (C_{TR}), as demonstrated by the following equation EQ(1):

$$\frac{Δ R}{R} = ( \frac{1 \partial R}{R \partial T} ) Δ T = {C}_{T R} Δ T . \qquad EQ ( 1 )$$

The change in thermoreflectance of the semiconductor channel region (between the gate and drain electrodes) of the semiconductor device 200 was first measured using a monochromator to determine the optimal probing wavelength for successive experiments.

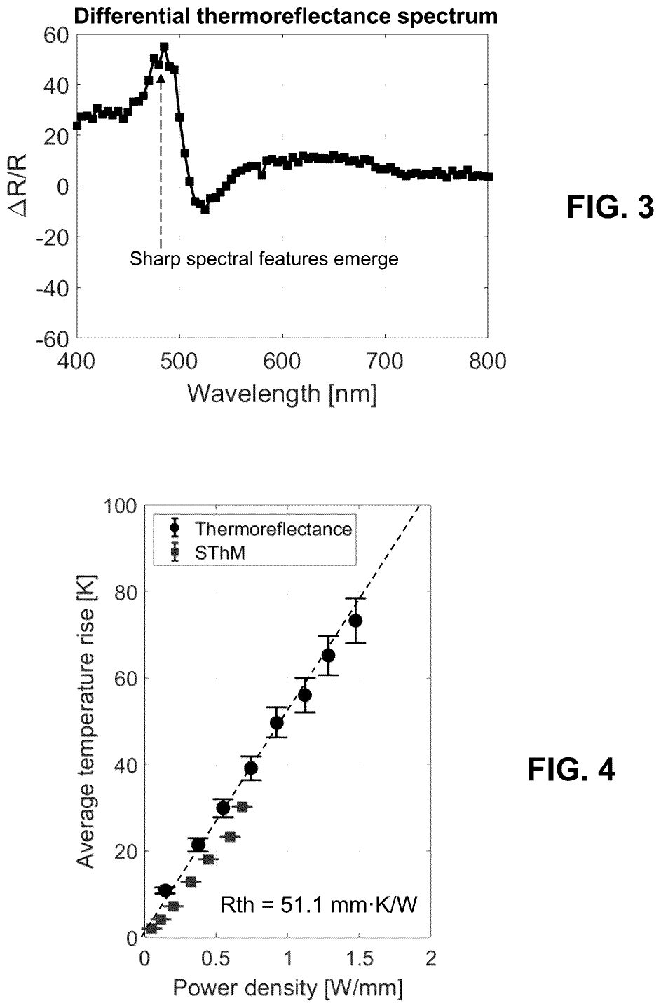

FIG. 3 depicts the change in reflectivity of the semiconductor device 200 with respect to light wavelength in nanometers. Results showed a positive peak in the thermoreflectance response of the semiconductor channel region (between the gate and drain electrodes) of the semiconductor device 200 around 470-490 nm. Accordingly, a full-field calibration of the semiconductor device 200 was performed using a 470 nm LED, and over five rectangular regions of interest, the resulting calibration map yielded an average thermoreflectance coefficient (C_{TR}) of 1.06±0.07×10⁻⁴ K⁻¹ from the exposed semiconductor surface. A 95% confidence interval is provided for the uncertainty in C_{TR}, calculated as 2.776 times the standard error of the mean.

Subsequently, the semiconductor device 200 was operated under pulsed-bias conditions with ON-state power densities ranging from 0.15 to 1.47 W/mm with a gate-source voltage (V_{GS}) of 0V, and the temperature rise in the semiconductor channel was measured using λ=470 nm. A region encompassing the drain-side of the gate to 3 μm into the drain-side of the channel was used to extract the average peak temperature rise in the channel at the drain-side of the gate. Peak temperature rise values are shown in FIG. 4, as discussed below.

FIG. 4 depicts a graph plotting peak temperature rise (circles) in the channel of the semiconductor device 200 as a function of the power density in watts per millimeter (W/mm). The temperatures are verified with the surface temperature (squares) measured with scanning thermal microscopy (SThM). By plotting the peak temperature rise in the channel as a function of the power density, a device-level thermal resistance of 51.1 mm·K/W was extracted. A temperature-calibrated scanning thermal microscopy (SThM) tip was used to validate the peak temperature rise measured by visible wavelength thermoreflectance, as depicted in FIG. 4.

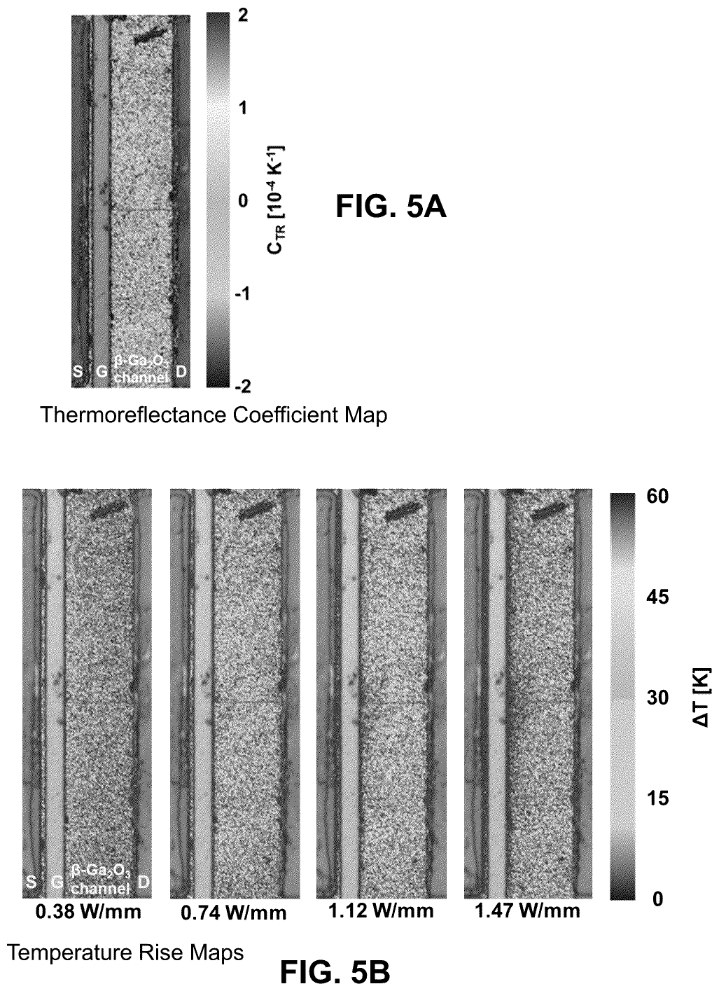

FIG. 5A shows an exemplary thermoreflectance coefficient map for the β-Ga₂O₃ channel in the semiconductor device 200 at a wavelength (λ) of 470 nm. In general, the thermoreflectance coefficient map displays pixel-by-pixel colors indicating thermoreflectance values of the β-Ga₂O₃ channel.

FIG. 5B shows exemplary temperature rise maps for the β-Ga₂O₃ channel in the semiconductor device 200 given a wavelength (λ) of 470 nm at different power densities (i.e., 0.38 watts per millimeter (W/mm), 0.74 W/mm, 1.12 W/mm and 1.47 W/mm). In general, the temperature rise maps comprise pixel-by-pixel colors indicating values associated with changes in temperature.

The temperature distribution across the entire length and width of the semiconductor device 200 was further measured with a, =470 nm probing wavelength, which, conveniently, also yields a peak in the thermoreflectance response for the Au-coated electrodes. Thus, the temperature rise in the channel of the semiconductor device 200 was measured using visible wavelength TTI, a feat previously thought unrealizable since the probing wavelength (470 nm) is sub-bandgap for ultrawide bandgap semiconductors. This unconventional approach was validated using temperature-calibrated scanning thermal microscopy, with good agreement between the temperature rise measured by the two methods. This work is significant because it forgoes the need for deep-UV LEDs and special optics to probe the thermal response of ultrawide bandgap HFETs, as well as bypasses the need for depositing any extraneous nanoparticles or miscellaneous coatings, which otherwise contaminate the device integrity. Furthermore, a single excitation wavelength (470 nm) can be used to measure the temperature rise on the metal electrodes and in the semiconductor channel simultaneously, reducing both the calibration demands and measurement acquisition time.

### Exemplary Method for Quantifying Thermal Performance of an Ultrawide Bandgap Semiconductor

A method is provided for quantifying the thermal performance of an ultrawide bandgap semiconductor material by directly measuring a surface temperature of the ultrawide bandgap semiconductor material utilizing visible wavelength thermoreflectance thermal imaging (TTI) at sub-bandgap wavelengths (e.g., 400-800 nm). Implementations of the invention may include one or more steps illustrated in FIGS. 6A and 6B.

FIGS. 6A and 6B show a flowchart of an exemplary method in accordance with aspects of the present invention. Steps of the method may be carried out in the environment of FIG. 1 and are described with reference to elements depicted in FIG. 1. With initial reference to FIG. 6A, steps 601-606 describe an iterative process (process I) performed to identify an optimal sub-bandgap wavelength (measurement wavelength) for the ultrawide bandgap material of interest based on relative changes in reflectivity of the semiconductor device as a function of wavelength. If the optimal sub-bandgap wavelength for the ultrawide bandgap material of interest is already known, it may be possible to forgo steps 601-606.

At 601, an ultrawide bandgap semiconductor material (e.g., 117) of a semiconductor device (e.g., 118) is illuminated by light (e.g., 121) from one or more light sources (e.g., 104) at a select probing wavelength. In implementations, the select probing wavelength has an energy less than the bandgap energy of the semiconductor material (e.g., ≈4.8 electronvolts (eV) for β-Ga₂O₃). The energy of a light wavelength or wavelength energy, is given by the equation EQ(2), wherein the energy E of a single photon, λ is the photon's wavelength, c is the speed of light in vacuum, and h is the Planck constant:

$$E ( e V ) = \frac{h c}{λ} . \qquad EQ ( 2 )$$

In embodiments, the one or more light sources comprise one or more light sources 104 of a TTI system 100. In implementations, the one or more light sources are in the form of light emitting diodes (LEDs) in combination with a monochromator configured to select a narrow band of individual wavelengths of light from the LEDs to be transmitted to the semiconductor device. In embodiments, the ultrawide bandgap material comprises β-Ga₂O₃. In some implementations, the light used to illuminate the ultrawide bandgap material has a select probing wavelength within the range of 400-800 nm. In some embodiments, the light used to illuminate the ultrawide bandgap material has a wavelength ranging from 470-490 nm, such as when the ultrawide bandgap material is Ga₂O₃. In implementations, the light energy used to illuminate the semiconductor device is much less than the bandgap energy of the ultrawide bandgap material such that the light does not interfere with or alter the operation of the semiconductor device. In embodiments, the light is at a visible wavelength whose energy (E_{light}) is much less than the bandgap energy of the ultrawide bandgap material (E_{g}), where the term much less is defined as

$$( {E}_{g} - {E}_{light} > 0.3 eV ) .$$

At 602, the semiconductor device (e.g., 118) is pulse-biased over a first period of time between an ON-state and an OFF-state at the selected probing wavelength and at a set power level. In implementations step 602 is implemented in a locked-in measurement averaging scheme, wherein the electrical pulse to the device and the light/LED pulse used to illuminate and probe the reflectivity of the device are synchronized. In embodiments, the period of time and the power level are selected such that the ultrawide bandgap material has a minimum temperature fluctuation of between 5 and 10 degrees Celsius (° C.) between the ON-state and OFF-state. In implementations, the period of time and power level are selected to achieve a minimum temperature fluctuation of at least 10° C. Advantageously, this temperature fluctuation at step 602 was found to increase signal strength of a thermoreflectance spectrum by ensuring a measurable change in reflectance. In embodiments, the computer processor 110 of the TTI system 100 synchronizes the illumination of the ultrawide bandgap material at step 601 with an application of power from the power supply 112 at 602 to bias the semiconductor device 118 over the first period of time between the ON-state and the OFF-state. In implementations, the semiconductor device can include, but not limited to, a diode or a transistor, and the computer 110 controls the application of power from the power supply 116 to electrodes (e.g., 119A, 119B) of the semiconductor device 118.

Step 603 comprises capturing a set of images, via one or more cameras (e.g., 102), of reflectivity (R) of the light (e.g., reflected light 122 of FIG. 1) off the ultrawide bandgap material (e.g., 117) over the period of time of step 604 as the semiconductor device is pulse-biased between the ON-state (heated) and OFF-state (unheated, R₀). The set of images includes images of the ultrawide bandgap material when the semiconductor device is in the OFF-state and images of the ultrawide bandgap material when the semiconductor device is in the ON-state. In implementations, each of the images comprises a pixel-by-pixel image of reflectivity. In some embodiments, in addition to capturing reflectivity of light off the ultrawide bandgap material, the set of images captures reflectivity of light off other portions of the semiconductor device, such as the electrodes, or the entire semiconductor device.

Step 604 comprises determining a relative change in reflectivity (ΔR/R₀) of the ultrawide bandgap material (e.g., 117) as a function of wavelength based on the first set of images. As noted below at step 605, step 604 is reiterated for different selected probing wavelengths, such that relative changes in reflectivity for different selected probing wavelengths are determined based on different sets of images. In implementations, the computer 110 implements step 604. Note that each pixel in an image will have its own ΔR/R₀ value. Thus, each image comprises a ΔR/R₀ pixel-by-pixel map. An average may be taken over a selected area of the image to obtain the ΔR/R₀.

Step 605 comprises reiterating steps 601-604 at different probing wavelengths to obtain changes in reflectivity for respective probing wavelengths. In one exemplary scenario, a semiconductor device to be characterized is pulse-biased 25 times, and the change in reflectivity (ΔR/R₀) between the OFF- and ON-states at a probing wavelength of 400 nm is measured to be ΔR/R₀=50. The next probing wavelength selected is 405 nm, and the semiconductor device is pulse-biased another 25 times while measuring the change in reflectivity between the OFF- and ON-state, resulting in ΔR/R₀=52. The next probing wavelength selected is 410 nm, and so on, until a ΔR/R₀ value is calculated for every 5 nm from 400-800 nm for one given device power condition (for example, 10 W/mm). Each set of images corresponds to a selected probing wavelength in a wavelength sweep. In one example, if a wavelength sweep comprises sweeping over 400-800 nm in 5 nm steps, the total images taken would comprise 81 sets of images corresponding to each wavelength in that range (i.e., 400, 405, 410, . . . 800 nm).

From the change in reflectivity values, an optical sub-bandgap wavelength can be determined at step 606 because the signal intensity (i.e., measurement sensitivity) is the best for the wavelength with the largest (absolute) value of ΔR/R₀. In one example, 470 nm results in the highest ΔR/R₀.

Step 606 comprises identifying an optimal sub-bandgap wavelength (defined as a maximum of ΔR/R₀), or optimal measurement wavelength, based on the ΔR/R₀ values for multiple probing wavelengths. In implementations, the computer 110 implements step 606 by plotting a change of reflectivity versus the wavelength of the light, which may be used to identify an optimal sub-bandgap wavelength defined as a maximum of ΔR/R₀. In alternative embodiments, a user manually plots a change in reflectivity versus wavelength to identify an optimal sub-bandgap wavelength. In embodiments, the optimal visible sub-bandgap wavelength is determined by pulse-biasing the semiconductor device and measuring the change in reflectance between the ON and OFF-states of the device as a function of wavelength from 400-800 nm using a monochromator as the light source.

Steps 607-616 describe a calibration procedure (process II) in accordance with embodiments of the invention. In general, the calibration procedure determines a thermoreflectance coefficient (C_{TR}) based on a change in reflectivity of the ultrawide bandgap material as a function of temperature. In implementations, the calibration process is performed to calibrate/measure a temperature dependent material behavior of the ultrawide bandgap material of interest.

Step 607 comprises uniformly heating the entire semiconductor device (e.g., 118) to a first temperature (e.g., by changing a stage temperature). In embodiments, the computer 110 causes the temperature-controlled stage 108 to heat the semiconductor device 118 in accordance with step 607. Alternatively, a user can manually initiate the heating of the temperature-controlled stage 108 at step 607.

Step 608 comprises illuminating, via one or more light sources (e.g., 104), the ultrawide bandgap material of the heated semiconductor device (e.g., 118) from step 607 at the optimal sub-bandgap wavelength determined at step 606. In implementations, the optimal sub-bandgap wavelength is between 470-490 nm (e.g., for gallium oxide materials).

Step 609 comprises capturing a set of images, via one or more cameras (e.g., 102), of reflectivity of the light off the ultrawide bandgap material (e.g., 117) at the first temperature. In implementations, each of the images comprises a pixel-by-pixel image of reflectivity. With the semiconductor device uniformly heated, each pixel of an image will convey a temperature dependent reflectance.

Step 610 comprises determining a reflectivity of the ultrawide bandgap material of the semiconductor device (e.g., 118) at the first temperature based on the images captured at step 609.

Step 611 comprises uniformly heating the semiconductor device to a second temperature, different from the first temperature. In embodiments, the computer 110 causes the temperature-controlled stage 108 to heat the semiconductor device 118 in accordance with step 611. Alternatively, a user can manually initiate the heating of the temperature-controlled stage 108 at step 611.

Step 612 comprises illuminating, via the one or more light sources (e.g., 104), the ultrawide bandgap material (e.g., 117) of the heated semiconductor device (e.g., 118) of step 611 at the optimal sub-bandgap wavelength determined at step 606.

Step 613 comprises capturing a set of images, via one or more cameras (e.g., 104), of reflectivity of the light off the ultrawide bandgap material at the second temperature. In implementations, each of the images comprises a pixel-by-pixel image of reflectivity, and each pixel of an image will convey a temperature dependent reflectance.

Step 614 comprises determining a reflectivity of the ultrawide bandgap material of the semiconductor device (e.g., 118) at the second temperature based on the images captured at step 613. Optionally, steps 607-610 can be repeated for any additional number of temperatures desired (e.g., a third temperature and a fourth temperature) to obtain additional reflectivity measurements based on sets of images taken at the respective temperatures.

Step 615 comprises determining a change in reflectivity (ΔR) of the ultrawide bandgap material between at least the first temperature and the second temperature based on the reflectivity determined at steps 610 and 614. Optionally, step 615 may determine a change in reflectivity for additional temperatures. In implementations, the computer 110 implements step 615.

Step 616 comprises determining a thermoreflectance coefficient (C_{TR}) of the ultrawide bandgap material based on the sets of images from steps 609 and 613 and temperatures utilized (i.e., at least the first and second temperatures). In implementations, a pixel-by-pixel calibration map (or thermoreflectance coefficient map) is automatically generated by the computer 110 based on the sets of images taken at steps 609 and 613. In embodiments, the ultrawide bandgap material is Ga₂O₃ and has an average thermoreflectance coefficient (C_{TR}) of 1.06×10⁻⁴ K⁻¹. In implementations, the computer 110 implements step 616 by converting the measured change in reflectivity between the first and second temperatures using the following equation EQ(3), with units of K⁻¹.

$${C}_{TR} = ( Δ R / {R}_{0} ) \times {( Δ T )}^{- 1} . \qquad EQ ( 3 )$$

Referring now to FIG. 6B, steps 617-623 describe an iterative process (i.e., process III) to determine temperature rise information for the ultrawide bandgap material of interested.

Step 617 comprises illuminating, via the one or more light sources (e.g., 104), the ultrawide bandgap material (e.g., 117) of the semiconductor device (e.g., 118) at the optimal sub-bandgap wavelength determined at step 606.

Step 618 comprises pulse-biasing the illuminated semiconductor device over a period of time between an ON-state and an OFF-state at a select probing power level. In implementations step 618 is implemented in a locked-in measurement averaging scheme, wherein the electrical pulse to the device and the light/LED pulse used to illuminate and probe the reflectivity of the device are synchronized. In implementations, the period of time and the select probing power level result in a minimum temperature fluctuation of the ultrawide bandgap material of 5-10° C. between the ON-state and OFF-state.

Step 619 comprises capturing a set of images, via the one or more cameras (e.g., 104), of reflectivity of the light off the ultrawide bandgap material over the period of time of step 618. The set of images includes images of the ultrawide bandgap material when the semiconductor device is in the OFF-state and images of the ultrawide bandgap material when the semiconductor device is in the ON-state. In implementations, each of the images comprises a pixel-by-pixel image of reflectivity.

Step 620 comprises determining a change in reflectivity (ΔR/R₀) of the ultrawide bandgap material based on the set of images, wherein the set of images are associated with the select probing power level. In embodiments, the computer 110 implements step 620.

Step 621 comprises repeating steps 617-620 at different probing power levels to obtain multiple ΔR/R₀ values for the respective probing power levels. In one exemplary scenario, a semiconductor device to be characterized is pulse-biased 25 times at select probing power levels while using the optimal wavelength (e.g., 470 nm) the entire period of time. As the power dissipation in the semiconductor device increases, the temperature of the semiconductor device will rise, which should result in a larger ΔR/R₀. In one example, if power densities are measured at 5, 10, 15, and 20 W/mm, the respective ΔR/R₀ may be 100, 200, 300, and 400.

At this point in the process, ΔR/R₀ and C_{TR} are known, so the change in temperature (ΔT) at different powers can be calculated using the following equation EQ(4) with units of K.

$$Δ T = ( Δ R / {R}_{0} ) \times {( {C}_{T R} )}^{- 1} . \qquad EQ ( 4 )$$

Step 622 comprises converting the change in reflectivity of the ultrawide bandgap material to a temperature rise map (i.e., a pixel-by-pixel temperature rise map) based on the thermoreflectance coefficient map (calibration map). In embodiments, the computer 110 implements step 622, including generating the temperature rise map. In implementations, the computer 110 converts the measured change in reflectance to a temperature rise map using EQ (4).

Step 623 comprises determining peak temperature rise of the ultrawide bandgap material based on the temperature rise map. In implementations, the change in reflectivity (ΔR/R₀) map and the calibration map are overlapped or aligned using the TTI system (automatically or manually), one or more filters is applied by the TTI system (automatically or manually), and the user and/or the computer 110 determines a surface temperature of the ultrawide bandgap material based on the aligned maps. In embodiments, the filtering comprises filtering, using the computer 110, the images to isolate low signal to noise ratio levels due to low levels of reflectivity from the ultrawide bandgap material at sub-bandgap wavelengths, wherein the signal to noise ratio is between 5:1 and 25:1.

While the method of FIGS. 6A and 6B are described with respect to the ultrawide bandgap material, it should be understood that other parts of the semiconductor device housing the ultrawide bandgap material may be characterized utilizing the above-identified steps.

FIG. 7 shows an exemplary locked-in average measurement scheme in accordance with embodiments of the invention. In implementations of the method of FIGS. 6A and 6B, electrical pulses 701, light pulses (e.g., LED pulses) 702, and rise in temperature 703 of the semiconductor device occur simultaneously in a coordinated manner as depicted in FIG. 7. This coordination is referred to as a locked-in average measurement scheme.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of quantifying a thermal performance of an ultrawide bandgap material of a semiconductor device, the method comprising:
determining an optimal sub-bandgap measurement wavelength for the ultrawide bandgap material based on relative changes in reflectivity of the ultrawide bandgap material as a function of wavelength;
determining a thermoreflectance coefficient (C_{TR}) of the ultrawide bandgap material based on a change in reflectivity of the ultrawide bandgap material, illuminated at the optimal sub-bandgap measurement wavelength, as a function of temperature; and
determining temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.

2. The method of claim 1, wherein the identifying the optimal sub-bandgap measurement wavelength comprises:
illuminating the ultrawide bandgap material at a select probing wavelength;
pulse-biasing the semiconductor device, at a set power level, between an ON-state and an OFF-state at the select probing wavelength for a period of time;
capturing a set of images of reflectivity of light off the ultrawide bandgap material over the period of time;
determining a relative change in reflectivity (ΔR/R₀) of the ultrawide bandgap material as a function of wavelength based on the set of images;
reiterating the steps of illuminating, pulse-biasing, capturing the set of images and determining the relative change in reflectivity of the ultrawide bandgap material at multiple select probing wavelengths, thereby determining changes in reflectivity of the ultrawide bandgap material for the multiple select probing wavelengths; and
determining the optimal sub-bandgap measurement wavelength based on the changes in reflectivity of the ultrawide bandgap material for the multiple probing wavelengths, wherein the optimal sub-bandgap measurement wavelength is one of the multiple probing wavelengths with the largest value of ΔR/R₀.

3. The method of claim 2, wherein the select probing wavelengths are wavelengths having an energy less than a bandgap energy of the ultrawide bandgap material.

4. The method of claim 3, wherein the select probing wavelengths are wavelengths having an energy (E_{light}) that is less than the bandgap energy of the ultrawide bandgap material (E_{g}), wherein E_{g}−E_{light}>0.3 electronvolts (eV).

5. The method of claim 2, wherein the select probing wavelengths are selected from the range of 320-800 nanometers.

6. The method of claim 2, wherein the period of time and the set power level result in a minimum temperature fluctuation of the semiconductor device between 5 and 10 degrees Celsius between the ON-State and the OFF-State.

7. The method of claim 1, wherein the determining the thermoreflectance coefficient (C_{TR}) of the ultrawide bandgap material comprises:
uniformly heating the semiconductor device to a first temperature while illuminated at the optimal sub-bandgap measurement wavelength;
capturing a first set of images of reflectivity of light off the ultrawide bandgap material at the first temperature;
uniformly heating the semiconductor device at a second temperature while illuminated at the optimal sub-bandgap measurement wavelength;
capturing a second set of images of reflectivity of light off the ultrawide bandgap material at the second temperature;
determining a change of reflectivity of the ultrawide bandgap material between at least the first temperature and the second temperature based on the first and second set of images; and
determining the thermoreflectance coefficient (C_{TR}) of the ultrawide bandgap material based on the change of reflectivity of the ultrawide bandgap material between at least the first temperature and the second temperature.

8. The method of claim 7 wherein the determining the thermoreflectance coefficient (C_{TR}) of the ultrawide bandgap material is based on a pixel-by-pixel calibration map.

9. The method of claim 1, wherein the determining the temperature rise characteristics of the ultrawide bandgap material comprises:
pulse-biasing the semiconductor device between an ON-state and an OFF-state for a period of time at a select probing power level while exposed to light at the optimal sub-bandgap measurement wavelength
capturing a set of images of reflectivity of the light off the ultrawide bandgap material over the period of time;
determining a change in reflectivity (ΔR/R₀) of the ultrawide bandgap material based on the set of images;
reiterating the steps of pulse-biasing, capturing the set of images, and determining the relative change in reflectivity of the ultrawide bandgap material at multiple select probing power levels, thereby determining changes in reflectivity of the ultrawide bandgap material for the multiple select probing power levels; and
determining the temperature rise characteristics of the ultrawide bandgap material based on the changes in reflectivity of the ultrawide bandgap material for the multiple select probing power levels.

10. The method of claim 9, wherein the determining the temperature rise characteristics of the ultrawide bandgap material based on the changes in reflectivity of the ultrawide bandgap material for the multiple select probing power levels comprises: converting the changes in reflectivity of the ultrawide bandgap material for the multiple different probing power levels to a temperature rise map.

11. The method of claim 9, wherein the period of time at the select probing power level results in a minimum temperature fluctuation of the semiconductor device between 5 and 10 degrees Celsius between the ON-State and the OFF-State.

12. The method of claim 1, further comprising determining a peak temperature rise of the ultrawide bandgap material based on the temperature rise characteristics.

13. The method of claim 1, wherein the ultrawide bandgap material is gallium oxide or aluminum gallium oxide.

14. The method of claim 1, wherein the optimal sub-bandgap measurement wavelength is between 470-490 nanometers (nm).

15. A system for quantifying thermal performance of an ultrawide bandgap material of a semiconductor device comprising:
a processor set, one or more computer readable storage media, and program instructions collectively stored on the one or more computer readable storage media, the program instructions executable to:
determine a thermoreflectance coefficient (C_{TR}) of the ultrawide bandgap material based on a change in reflectivity of the ultrawide bandgap material, illuminated at an optimal sub-bandgap measurement wavelength, as a function of temperature; and
determine temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.

16. The system of claim 15, further comprising one or more light sources and a monochromator configured to illuminate the ultrawide bandgap material.

17. The system of claim 15, further comprising one or more cameras configured to take images of the ultrawide bandgap material.

18. The system of claim 15, further comprising a temperature-controlled stage configured to selectively heat the semiconductor device.

19. The system of claim 15, further comprising a power source configured to selectively bias the semiconductor device.

20. A computer program product comprising one or more computer readable storage media having program instructions collectively stored on the one or more computer readable storage media, the program instructions executable to:
determine a thermoreflectance coefficient (C_{TR}) of the ultrawide bandgap material based on a change in reflectivity of the ultrawide bandgap material, illuminated at an optimal sub-bandgap measurement wavelength, as a function of temperature; and
determine temperature rise characteristics of the ultrawide bandgap material based on: a change in reflectivity of the ultrawide bandgap material, illuminated at the optimal sub-bandgap measurement wavelength, as a function of a power level applied to the semiconductor device; and the thermoreflectance coefficient (C_{TR}) of the ultrawide bandgap material.
